(19) United States
(12) Patent Application Publication
(10) Pub. No.: US 2007/0277018 A1
(43) Pub. Date: Nov. 29, 2007

(54) Storage area allocating apparatus, storage area allocating method, and computer product

(75) Inventor: Isao Tanaka, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: Fujitsu Limited, Kawasaki-shi (JP)

(21) Appl. No.: 11/803,847

(22) Filed: May 16, 2007

Related U.S. Application Data
(63) Continuation of application No. PCT/JP04/17024, filed on Nov. 16, 2004.

(51) Int. Cl. G06F 12/00

(52) U.S. Cl. 711/171

(57) ABSTRACT

A capacity calculator identifies a data area required by an application by using capacity calculation information stored in a capacity-calculation-information storage unit, and calculates the capacity of the identified respective data areas. A virtual-disk allocating unit allocates a virtual disk associated with a physical disk to the data area, the capacity of which is calculated by the capacity calculator. Further, the virtual-disk allocating unit associates the physical disk with the virtual disk based on an arrangement restriction among data areas.

### BACKGROUND OF THE INVENTION

1. Field of the Invention

The present invention relates to a technology for allocating a storage area used by an application from a storage unit.

2. Description of the Related Art

Conventionally, when a database is established, a system engineer (SE) or a system administrator determines a capacity to be allocated to a database space, and a capacity to be allocated to a data area for each associated type such as dictionary area and a log area, by adding empirical to a recommendation value (obtained from a calculating formula described in a manual or the like), based on the data capacity to be stored in the database.

The system engineer or the system administrator then ensures an area such as the database space by specifying the capacity together with an attribute such as a performance of a storage unit to be required and its reliability. A conventional technique has been disclosed in, (for example, Japanese Patent Application Laid-open No. 2002-222061.

To calculate a capacity of a data area, however, the calculation needs to be performed by a complicated calculating formula, and therefore work efficiency of a system engineer (SE) or a system administrator is inefficient. Furthermore, there are limitations such that a database space area, a dictionary area, and a log area cannot be placed in the same disk drive, or they should not be placed in the same disk drive according to a purpose of use thereof. Therefore, there has been a problem that it has to be considered as to which data area is to be allocated to which disk drive.

### SUMMARY OF THE INVENTION

It is an object of the present invention to at least partially solve the problems in the conventional technology.

According to an aspect of the present invention, a storage area allocating apparatus that allocates a storage area to be used by an application from a storage unit, the storage area allocating apparatus includes a capacity calculating unit that identifies a data area for each type required by the application and calculates a capacity of identified data area; and an area allocating unit that allocates a storage area having the capacity calculated by the capacity calculating unit as the data area from the storage unit.

According to another aspect of the present invention, a method of allocating a storage area to be used by an application from a storage unit, the method includes identifying a data area for each type required by the application; calculating a capacity of the data area identified at the identifying; and allocating a storage area having the capacity calculated at the calculating as the data area from the storage unit.

According to still another aspect of the present invention, a computer-readable recording medium stores therein a computer program that causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of a system configuration of a virtualized storage system according to an embodiment of the present invention;

FIG. 2 is a schematic diagram for explaining a relationship between a virtual disk and a physical disk;

FIG. 3 is a schematic diagram for explaining allocation of a physical disk by a disk virtualizing unit;

FIG. 4 is a functional block diagram of a configuration of the disk virtualizing unit;

FIG. 5 is an example of a data structure of capacity calculation information stored in a capacity-calculation-information storage unit;

FIG. 6A is an example of a status of use of a physical disk;

FIG. 6B is an example of disk-drive-use information stored in a disk-drive-use-information storage unit;

FIG. 7 is an example of disk-capacity-allocation associated information stored in a disk-capacity-allocation-associated-information storage unit;

FIG. 8 is an example of a data structure of virtual-disk allocation information stored in a virtual-disk-allocation-information storage unit;

FIG. 9 is a flowchart of a virtual-disk-allocation process procedure performed by the disk virtualizing unit;

FIG. 10 is a flowchart of a virtual-disk-drive-allocation process procedure; and

FIG. 11 depicts a hardware configuration of a fiber channel switch that executes a disk virtualizing program according to the embodiment.

### DETAILED DESCRIPTION OF THE PREFERRED EMBODIMENTS

Exemplary embodiments of the present invention will be explained below in detail with reference to the accompanying drawings. In the embodiments, a case that the present invention is applied to a fiber channel switch is mainly explained.

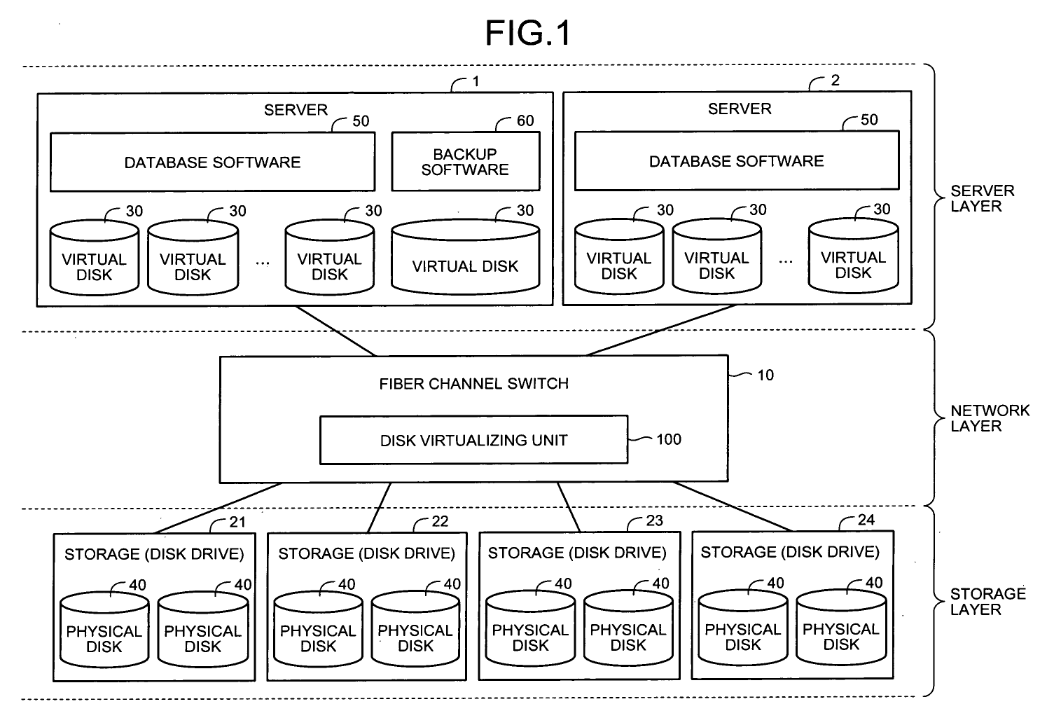

A system configuration of a virtualized storage system according to an embodiment of the present invention is explained first. FIG. 1 is a functional block diagram of the system configuration of the virtualized storage system according to the embodiment.

As shown in FIG. 1, the virtualized storage system is formed by connecting servers 1 and 2 to storages 21 to 24 via a fiber channel switch 10. For the sake of explanation, only two servers and four storages are shown, however, an optional number of servers and storages are connected to the fiber channel switch 10. The storages 21 to 24 are respectively a disk drive.

In the virtualized storage system, for example, when the server 1 requests the fiber channel switch 10 to allocate a disk area, a disk virtualizing unit 100 in the fiber channel switch 10 virtualizes the storage to allocate a virtual disk 30 to the server 1, and allocate a physical disk 40 from the storage corresponding to the virtual disk 30.

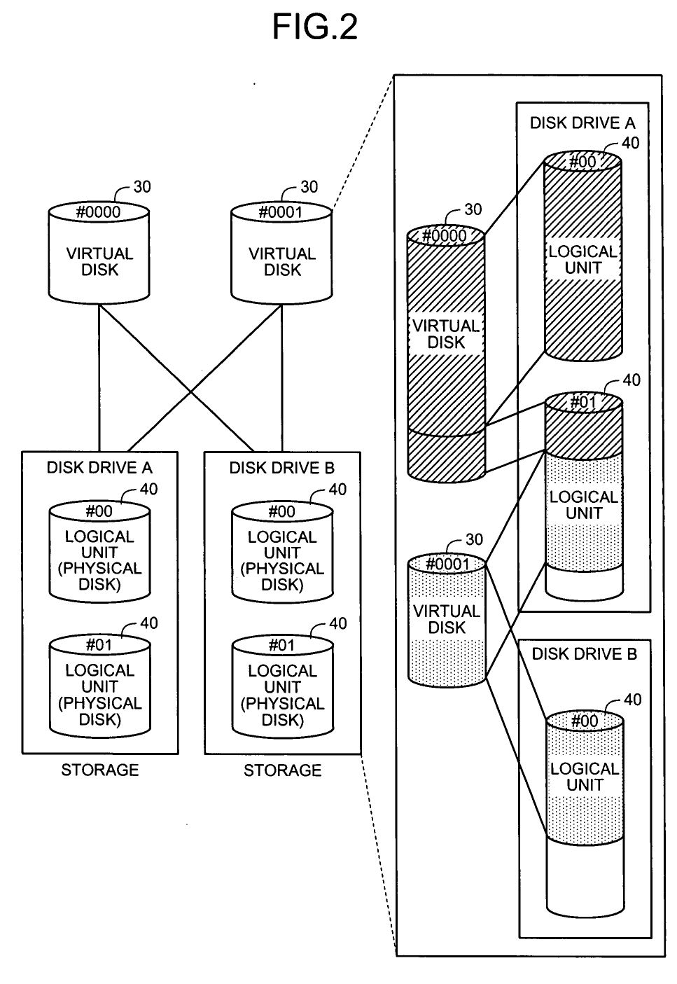

FIG. 2 is a schematic diagram for explaining a relationship between the virtual disk 30 and the physical disk 40. As shown in FIG. 2, the virtual disk 30 “#0000” is formed of the entire physical disk 40 (logical unit) “#00” of a disk drive A and a part of the physical disk 40 “#01” of a disk drive B. The virtual disk 30 “#0001” is formed of a part of the physical disk 40 “#01” of the disk drive A and a part of the physical disk 40 “#00” of the disk drive B.

Thus, in some cases, the virtual disk 30 to be allocated to a server by the disk virtualizing unit 100 is formed of a plurality of the physical disks 40 of one disk drive, and in some cases, the virtual disk 30 is formed of a plurality of the physical disks 40 of a plurality of disk drives. That is, the configuration of the virtual disk 30 is separated from a physical configuration of the storage, and the application such as database software 50 and backup software 60 that operate on the server can use the storage without being affected by a change of the physical configuration of the storage.

For example, when the database software 50 in the server 1 requests allocation of the disk area, the disk virtualizing unit 100 receives information indicating that the application having requested the disk area is the database software 50 and a variable value that affects the capacity of the database to specify the data area for each type (for each purpose of use) of the database space, the dictionary, and the log management required by the database software 50, calculates the capacity of the respective data areas, and allocates the virtual disk 30 and the physical disk 40. As the variable affecting the capacity of the database, for example, the record length and the number of records can be mentioned.

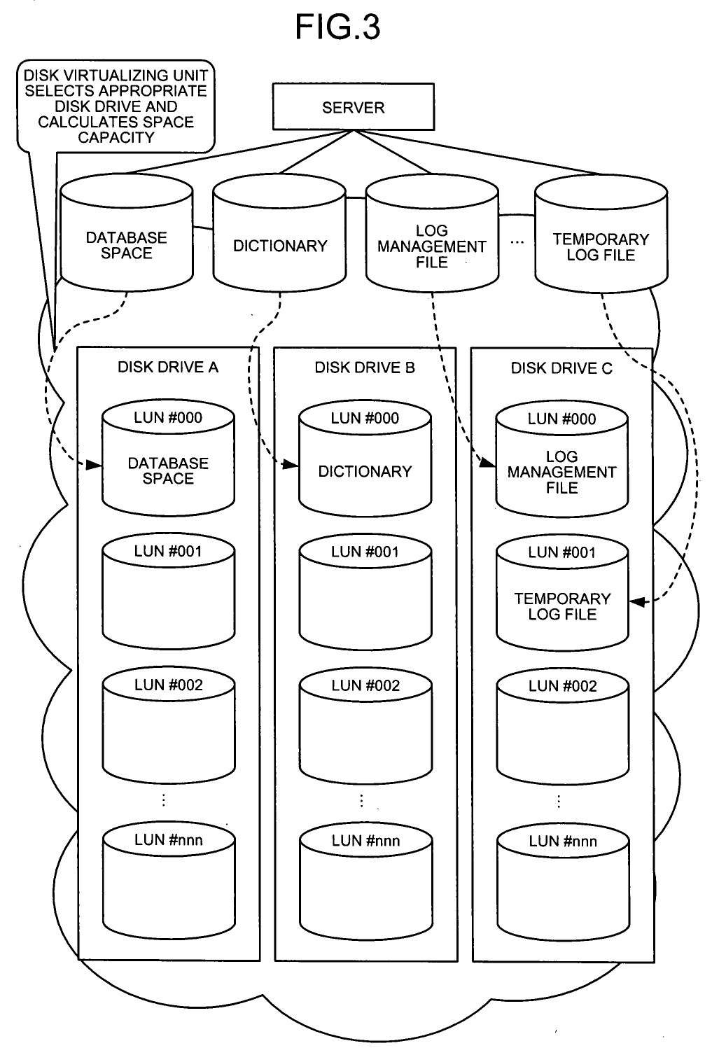

FIG. 3 is a schematic diagram for explaining allocation of the physical disk 40 by the disk virtualizing unit 100. As shown in FIG. 3, when the database software 50 requests allocation of the disk area, the disk virtualizing unit 100 identifies the data area for each type of the database space, the dictionary, a log management file, and a temporary log file required by the database software 50, and calculates the capacity of the respective data areas to allocate the virtual disk 30 and the physical disk 40 to the database software 50.

For example, the disk virtualizing unit 100 allocates the physical disk 40 having a logical unit number (LUN) “#000” in the disk drive A to the database space, and allocates the physical disk 40 having the LUN “#000” in the disk drive B to the dictionary. The disk virtualizing unit 100 then allocates the physical disk 40 having the LUN “#000” in disk drive C to the log management file, and allocates the physical disk 40 having the LUN “#001” in disk drive C is to the temporary log file.

In this manner, the disk virtualizing unit 100 receives the information of the application having requested the disk area and the variable value that affects the capacity of the disk area from the server, identifies the data area for each type required by the application, and calculates the capacity of the respective areas to allocate the virtual disk 30 and the physical disk 40. Accordingly, the system administrator can efficiently allocate the disk area.

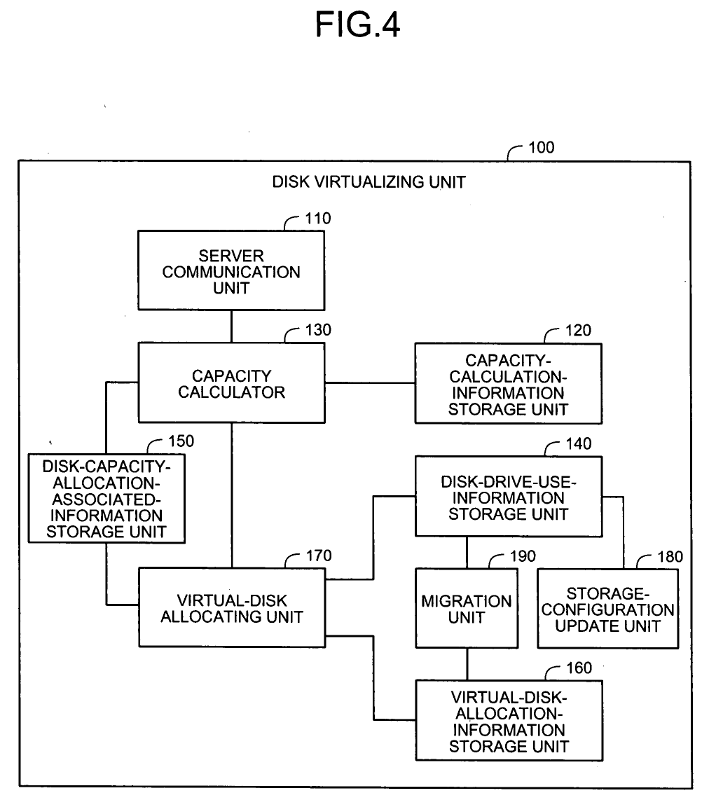

The configuration of the disk virtualizing unit 100 is explained next. FIG. 4 is a functional block diagram of the configuration of the disk virtualizing unit 100. As shown in FIG. 4, the disk virtualizing unit 100 includes a server communication unit 110, a capacity-calculation-information storage unit 120, a capacity calculator 130, a disk-drive-use-information storage unit 140, a disk-capacity-allocation-associated-information storage unit 150, a virtual-disk-allocation-information storage unit 160, a virtual-disk allocating unit 170, a storage-configuration update unit 180, and a migration unit 190.

The server communication unit 110 is a processor that communicates with the servers 1 and 2, and receives a disk-area allocation request from, for example, the server 1 and transmits the information relating to the allocated virtual disk 30 to the server 1.

The capacity-calculation-information storage unit 120 stores the information required for the disk virtualizing unit 100 to identify the disk area required by the application and calculate the capacity of each of the area.

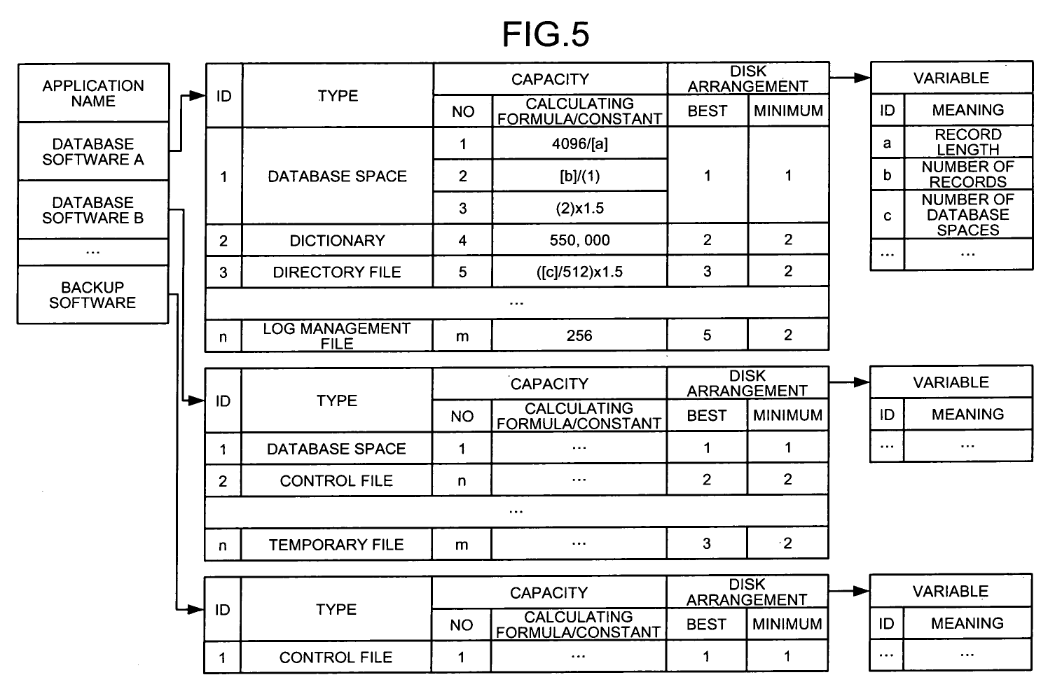

FIG. 5 is an example of a data structure of capacity calculation information stored in the capacity-calculation-information storage unit 120. As shown in FIG. 5, the capacity-calculation-information storage unit 120 stores an application name, which is the name of the application that has requested allocation of the disk area, the data area for each type required by the application, a calculating formula of the capacity of each data area, and disk arrangement for each application. The disk arrangement means an arrangement of the data area on the physical disk 40 based on the restriction among the respective data areas, and the “best” indicates the best arrangement and “minimum” indicates a minimum arrangement that satisfies a minimum necessary condition.

For example, database software A requires the data area for each type of the database space, the dictionary, a directory file, and the log management file. When it is assumed that a record length is a, and the number of records is b, the number of database spaces is c, which is the capacity of the database, the relationship among the a, b, and c is c=b/(4096/a)×1.5.

Assuming that the number of database spaces is 3, for a database space (No) “1”, the calculating formula is 4096/a, which will be referred to as calculating formula (1). For a database space “2”, the calculating formula is ([b]/calculating formula (1)), that is to say ([b]/(4096/a)), which will be referred to as calculating formula (2). Finally, for a database space “3”, the calculating formula is (calculating formula (2)×1.5), that is to say ([b]/(4096/a)×1.5).

Further, as the arrangement of the physical disk 40 relative to each data area, the best arrangement is such that the database space, the dictionary, the directory file, and the log management file are allocated to another physical disk 40 having a different number from each other, that is, to a different physical disk 40, and an arrangement in which only the database space is allocated to another physical disk 40 different from other data areas is the minimum necessary arrangement that satisfies the minimum necessary condition.

The capacity calculator 130 uses the capacity calculation information stored in the capacity-calculation-information storage unit 120 to identify the data area for each type required by the application specified by the server, and the capacity calculator 130 calculates the capacity of the respective data areas. The capacity calculator 130 stores the calculated capacity in the disk-capacity-allocation-associated-information storage unit 150.

When there is information required for calculating the capacity other than the application information, the capacity calculator 130 receives the information from the server to calculate the capacity. The information required for calculating the capacity includes the record length and the number of records, for example, in the case of the database software 50.

The capacity calculator 130 identifies the data area for each type required by the application and calculates the capacity of the respective data areas, thereby improving the efficiency of allocating the disk area to each application.

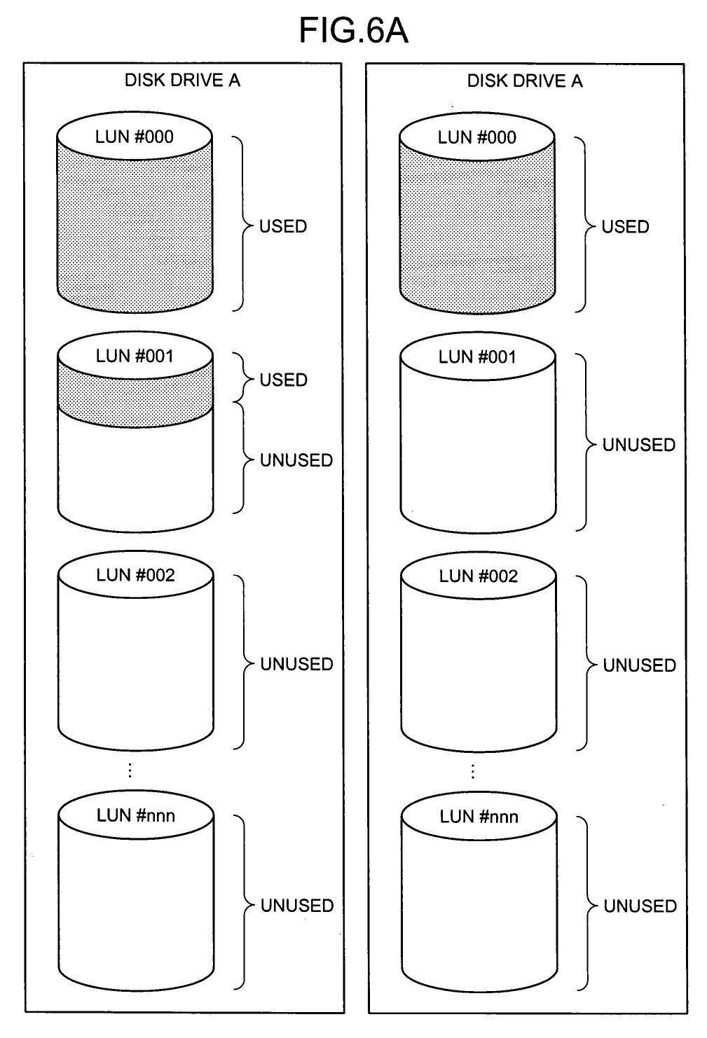

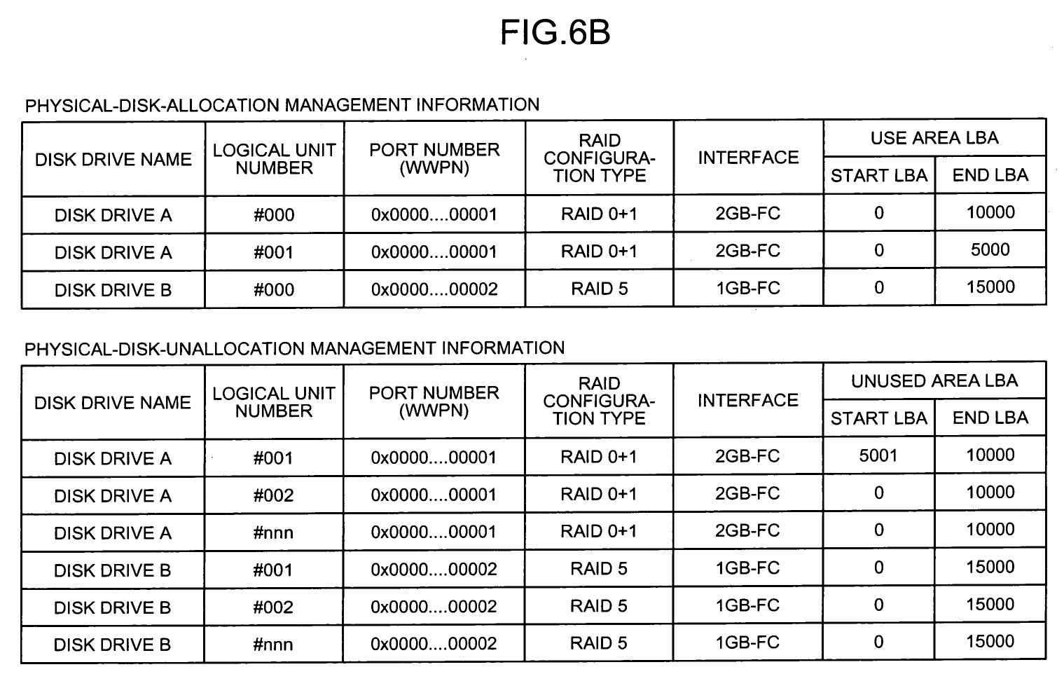

The disk-drive-use-information storage unit 140 stores disk-drive use information, which is the information relating to a status of use of the physical disk 40. For example, when the status of use of the physical disk 40 is as shown in FIG. 6A, the disk-drive-use-information storage unit 140 stores physical-disk-allocation management information and physical-disk-unallocation management information as shown in FIG. 6B as the disk-drive use information.

The physical-disk-allocation management information relates to the area of the physical disk 40 being used, and includes a name of the disk drive, a logical unit number, a port number, a redundant array of inexpensive disk (RAID) configuration type, an interface, and a use area logical block address (LBA).

The interface indicates a data transfer rate with the fiber channel switch 10, and for example, “2 GB-FC” indicates that the data transfer rate with the fiber channel switch 10 is 2G byte per second. The use area LBA is formed of a start LBA indicating a head block address of the use area and an end LBA indicating an end block address of the use area.

The physical-disk-unallocation management information relates to the area of the physical disk 40 not being used, and includes a name of the disk drive, a logical unit number, a port number, a RAID configuration type, an interface, and an unused area LBA. The unused area LBA is formed of a start LBA indicating a head block address of the unused area and an end LBA indicating an end block address of the unused area.

As shown in FIG. 6A, in this example, the logical unit having a logical unit number “#000” in disk drive A and the logical unit having the logical unit number “#000” in disk drive B are all used, and the logical unit having a logical unit number “#001” in disk drive A is partially used.

At this time, as shown in FIG. 6B, the disk-drive-use-information storage unit 140 stores the information relating to the entire area of the logical unit having the logical unit number “#000” in disk drive A and the logical unit having the logical unit number “#000” in disk drive B, and a part of the logical unit having the logical unit number “#001” in disk drive A as the physical-disk-allocation management information, and stores the information of the remaining areas as the physical-disk-unallocation management information.

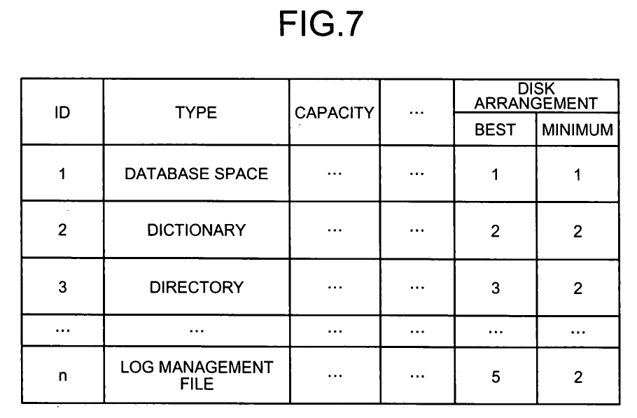

The disk-capacity-allocation-associated-information storage unit 150 temporarily stores the capacity of the respective data areas calculated by the capacity calculator 130, the disk arrangement, and the like as disk-capacity-allocation associated information. FIG. 7 is an example of the disk-capacity-allocation associated information stored in the disk-capacity-allocation-associated-information storage unit 150.

As shown in FIG. 7, the disk-capacity-allocation associated information includes an ID for identifying each data area for each type of the database space, the dictionary, the directory, the log management file or the like to be allocated in response to a disk area allocation request from the database software A shown in FIG. 5, the capacity of each data area, and the disk arrangement.

The virtual-disk-allocation-information storage unit 160 stores information of the virtual disk 30 and the physical disk 40 allocated to the application as virtual-disk allocation information.

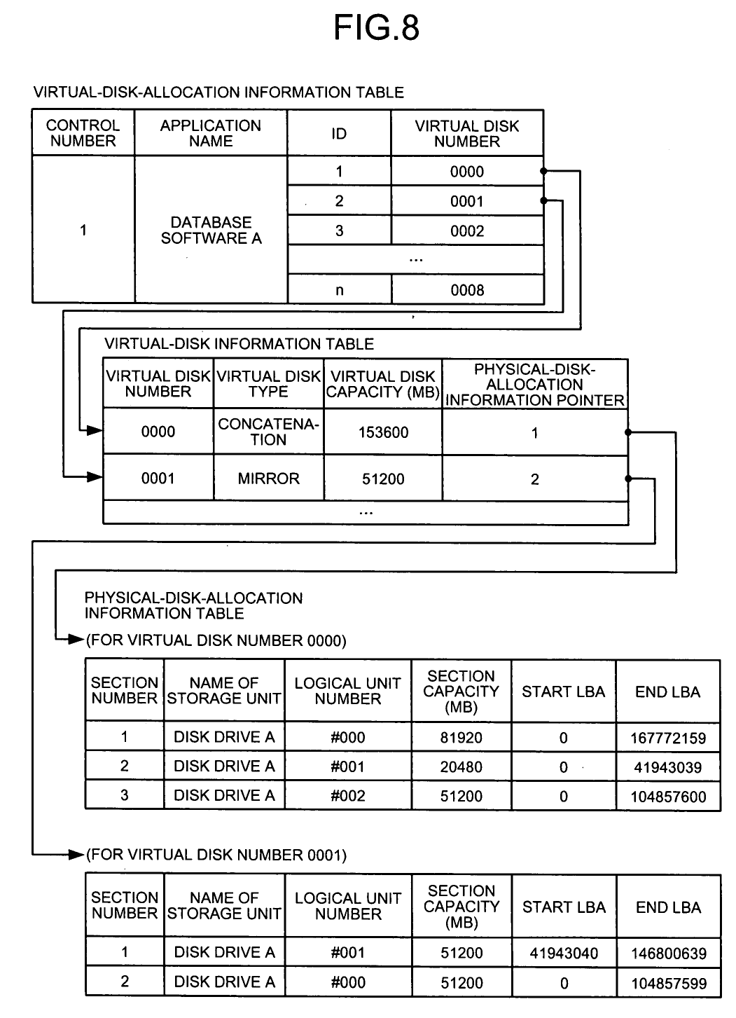

FIG. 8 is an example of a data structure of the virtual-disk allocation information stored in the virtual-disk-allocation-information storage unit 160. As shown in FIG. 8, the virtual-disk allocation information includes a virtual-disk-allocation information table, a virtual-disk information table, and a physical-disk-allocation information table.

The virtual-disk-allocation information table stores information of the virtual disk 30 allocated to the application, and stores the control number for controlling the application, application name, an ID for identifying each data area for each type required by the application, and a virtual disk number for identifying the virtual disk 30 allocated to each data area for each application.

The virtual-disk information table stores information of the virtual disk 30, and stores the virtual disk number, the virtual disk type, the virtual disk capacity, and a physical-disk-allocation information pointer, which is a pointer to the physical-disk-allocation information table, for each virtual disk 30.

The physical-disk-allocation information table stores information of the physical disk 40 corresponding to the virtual disk 30, and is generated when the virtual-disk allocating unit 170 allocates the virtual disk 30 to the application. Accordingly, the virtual-disk-allocation-information storage unit 160 stores the same number of physical-disk-allocation information tables as the number of the virtual disks 30.

The physical-disk-allocation information table stores a section number for identifying a section of the physical disk 40 constituting the virtual disk 30, a storage name indicating the disk drive to which the section belongs, a logical unit number for identifying the logical unit in the storage, a section capacity, a start LBA, and an end LBA for each section. When the virtual disk 30 is increased, a new section is added to the physical-disk-allocation information table.

For example, the virtual disk 30 having the virtual disk number “0000” includes three sections, where a section with the section number “1” is in the logical unit having the logical unit number “#000” in disk drive A, the capacity thereof is 81920 MB, with a start LBA being “0” and an end LBA being “167772159”. When the virtual disk 30 is increased, a new section is added to the physical-disk-allocation information table.

The virtual-disk allocating unit 170 allocates the virtual disk 30 and the physical disk 40 based on the disk-capacity-allocation associated information stored in the disk-capacity-allocation-associated-information storage unit 150, and stores the allocation result in the virtual-disk-allocation-information storage unit 160.

The virtual-disk allocating unit 170 allocates the physical disk 40 based on the best arrangement, of the disk arrangement in the disk-capacity-allocation associated information, and when the best arrangement is not possible, performs allocation according to the minimum arrangement.

The storage-configuration update unit 180 updates information in the disk-drive-use-information storage unit 140 when there is an addition or change of the disk drive constituting the virtualized storage system.

When the physical disk 40 currently being used is to be replaced, the migration unit 190 shifts data stored in an old physical disk 40 to a new physical disk 40. At the time of this shift, the migration unit 190 allocates the storage area according to the best arrangement as much as possible relative to the data area of the application where the best arrangement has not been performed.

Because the migration unit 190 allocates the storage area according to the best arrangement as much as possible relative to the data area of the application where the best arrangement has not been performed, the reliability and the performance of the virtualized storage system can be improved due to addition or the like of the disk drive.

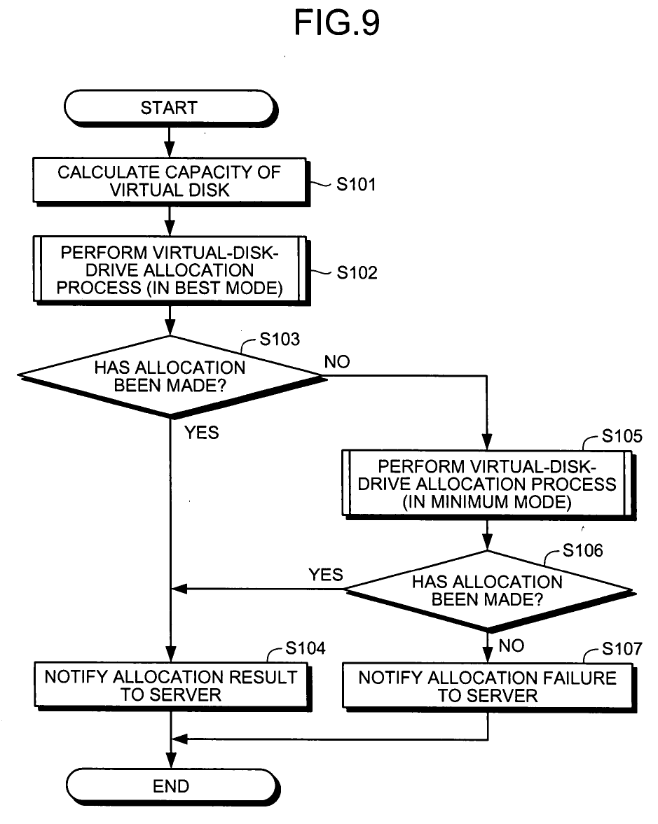

A virtual-disk-allocation process procedure performed by the disk virtualizing unit 100 is explained next. FIG. 9 is a flowchart of the virtual-disk-allocation process procedure performed by the disk virtualizing unit 100. A case that the disk area allocation request is received from the server 1 is explained below as an example.

As shown in FIG. 9, when the disk virtualizing unit 100 receives the disk area allocation request relative to the application from the server 1, the capacity calculator 130 identifies the data area for each type required by the application, using the information stored in the capacity-calculation-information storage unit 120, thereby calculating the capacity of the respective data areas (step S101).

The virtual-disk allocating unit 170 then performs a virtual-disk-drive allocation process for allocating the virtual disk 30 having the capacity calculated by the capacity calculator 130 and the corresponding physical disk 40. The virtual-disk allocating unit 170 performs the virtual-disk-drive allocation process in the best mode for performing the allocation according to the best arrangement (step S102).

It is determined whether the allocation according to the best arrangement can be performed (step S103), and when the allocation according to the best arrangement can be performed, the allocation result is notified to the server 1 (step S104). On the other hand, when the allocation according to the best arrangement cannot be performed, the virtual-disk-drive allocation process is performed based on a minimum mode for performing the allocation according to the minimum arrangement (step S105).

It is then determined whether the allocation according to the minimum arrangement can be performed (step S106), and when the allocation according to the minimum arrangement can be performed, the allocation result is notified to the server 1 (step S104), or when the allocation according to the minimum arrangement cannot be performed, an allocation failure is notified to the server 1 (step S107).

In this manner, the capacity calculator 130 identifies the data area for each type required by the application to calculate the capacity of the respective data areas, and the virtual-disk allocating unit 170 allocates the virtual disk 30 having the capacity calculated by the capacity calculator 130 and the corresponding physical disk 40. Accordingly, the allocation of the disk area to the application can be efficiently performed.

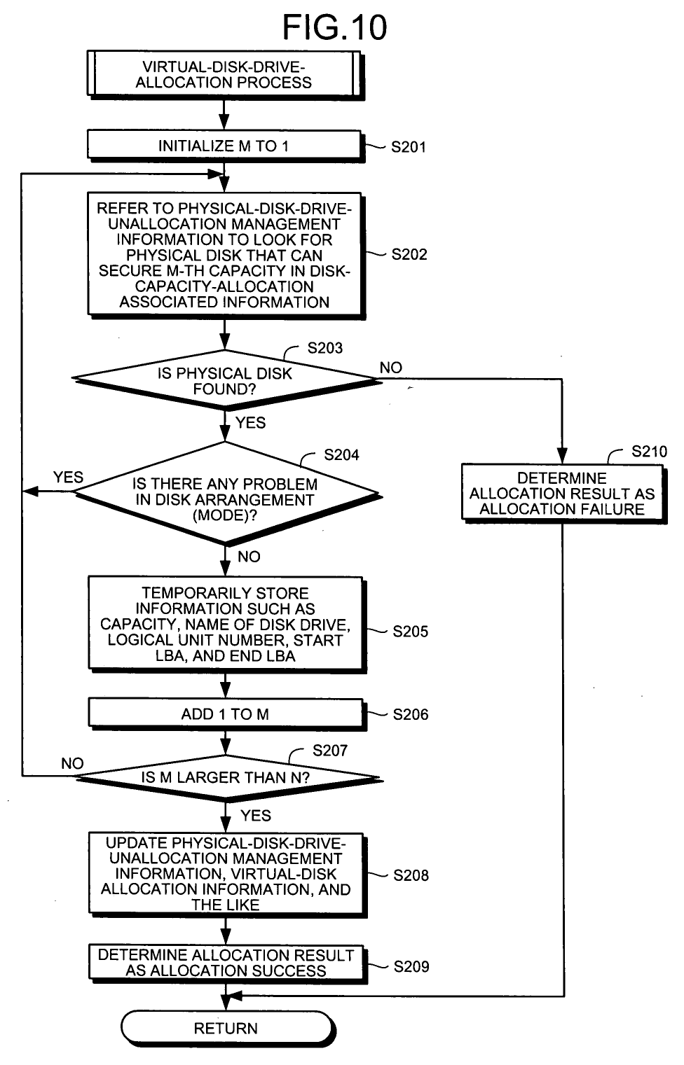

A virtual-disk-drive-allocation process procedure performed at steps S102 and S105 is explained next. FIG. 10 is a flowchart of the virtual-disk-drive-allocation process procedure. The virtual-disk-drive-allocation process is started when it is started up, by specifying whether the disk arrangement is performed according to the best arrangement or the minimum arrangement.

As shown in FIG. 10, in the virtual-disk-drive-allocation process, a value of a variable m is initialized to “1” (step S201). The physical disk 40 that can secure the m-th capacity in the disk-capacity-allocation associated information is then looked for by referring to the physical-disk-drive-unallocation management information in the disk-drive-use-information storage unit 140 (step S202).

When the physical disk 40 is found (YES at step S203), it is determined whether there is a problem in the disk arrangement (step S204). When there is a problem, control returns to step S202 to look for another physical disk 40.

On the other hand, if there is no problem in the disk arrangement, information such as the capacity, a disk drive name, a logical unit number, a start LBA, and an end LBA is temporarily stored (step S205), and “1” is added to m (step S206).

It is then determined whether m is larger than n, that is, whether the physical disk 40 can be allocated to the entire data area stored in the disk-capacity-allocation-associated-information storage unit 150 (step S207). When m is not larger than n, control returns to step S202 to look for the physical disk 40 to be allocated to the data area.

On the other hand, when m is larger than n, that is, when the physical disk 40 can be allocated to the entire data area stored in the disk-capacity-allocation-associated-information storage unit 150, the physical-disk-drive-allocation management information and the physical-disk-drive-unallocation management information in the disk-drive-use-information storage unit 140, and the virtual-disk allocation information stored in the virtual-disk-allocation-information storage unit 160 are updated (step S208) to return to step S201, determining the allocation result as an allocation success (step S209).

Whereas, when the physical disk 40 is not found (NO at step S203), control returns to step S201, determining the allocation result as an allocation failure (step S210).

In this manner, in the virtual-disk-drive allocation process, the physical disk 40 is allocated to the data area stored in the disk-capacity-allocation-associated-information storage unit 150 to update the information of the disk-drive-use-information storage unit 140 and the virtual-disk-allocation-information storage unit 160. Accordingly, the virtual disk 30 associated with the physical disk 40 can be allocated.

As described above, in the present embodiment, the capacity calculator 130 identifies the data area for each type required by the application, using the capacity calculation information stored in the capacity-calculation-information storage unit 120 and calculates the capacity of the respective data areas, and the virtual-disk allocating unit 170 allocates the virtual disk 30 associated with the physical disk 40 to the data area, the capacity of which is calculated by the capacity calculator 130. Accordingly, the disk area required by the application can be efficiently allocated.

In the present embodiment, a case that the disk area required by the application is allocated first has been explained. However, the status of use of the allocated disk area is monitored, and when the disk area is used exceeding a predetermined percentage, the disk area can be automatically increased. When the capacity of the data area is expanded, the data area associated with the data area can be automatically expanded.

For example, in the database system, when the used capacity of the database space exceeds a certain threshold, the capacity of the database space is increased, and the capacity of the dictionary, the log file, and the like can be also increased in proportion to the expansion of the capacity of the database space.

In the present embodiment, a case that the physical disk 40 is allocated so that the disk arrangement condition of the data area for each type required by the application is satisfied has been explained. However, conditions such as the RAID configuration and the interface with the fiber channel switch are associated with the data area, so that the physical disk 40 can be allocated to satisfy these conditions.

Although the database software 50 has been mainly explained above, the present invention is not limited thereto, and is also applicable to other types of software using a storage system such as the backup software 60.

Although the virtualized storage system has been explained above, the present invention is not limited thereto, and is also applicable to a case that the physical disk 40 is directly allocated without using the virtualized storage technology.

Although the disk virtualizing unit 100 in the fiber channel switch 10 has been explained above, the present invention is not limited thereto, and the disk virtualizing unit can be provided in other units that connect the server and the disk drive with each other.

In the present embodiment, the disk virtualizing unit 100 in the fiber channel switch 10 has been explained. However, by realizing the configuration of the disk virtualizing unit 100 by software, a disk virtualizing program having the same function can be obtained as an embodiment of the storage area allocating program. A hardware configuration of the fiber channel switch that executes the disk virtualizing program is explained below.

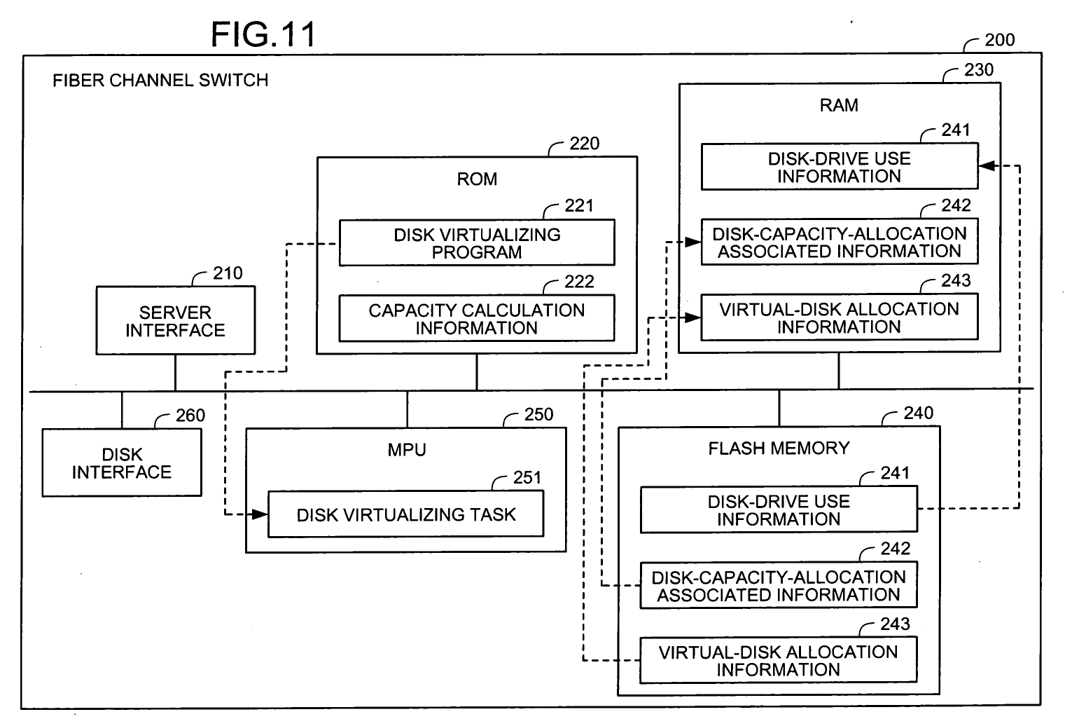

FIG. 11 depicts the hardware configuration of the fiber channel switch that executes the disk virtualizing program according to the present embodiment. As shown in FIG. 11, a fiber channel switch 200 includes a server interface 210, a read only memory (ROM) 220, a random access memory (RAM) 230, a flash memory 240, a micro processing unit (MPU) 250, and a disk interface 260.

The server interface 210 communicates with the server, and the ROM 220 is a read only memory that stores a disk virtualizing program 221, capacity calculation information 222 shown in FIG. 5, and the like.

The RAM 230 stores an interim result of execution of the disk virtualizing program 221, disk-drive use information 241 shown in FIG. 6B, disk-capacity-allocation associated information 242 shown in FIG. 7, virtual-disk allocation information 243 shown in FIG. 8, and the like.

The flash memory 240 is a nonvolatile memory that stores the disk-drive use information 241, the disk-capacity-allocation associated information 242, the virtual-disk allocation information 243, and the like, and the MPU 250 is a processor that reads the program stored in the ROM 220 to execute the program. The disk interface 260 communicates with the disk drive.

The disk virtualizing program 221 stored in the ROM 220 is read by the MPU 250 and executed as a disk virtualizing task 251. At this time, the disk-drive use information 241, the disk-capacity-allocation associated information 242, and the virtual-disk allocation information 243 stored in the flash memory 240 are read by the RAM 230 and updated.

According to an aspect of the present invention, the system administrator can allocate the storage area to the application without calculating the capacity of the data area for each purpose of use (for each type). Accordingly, the efficiency of allocating the storage area to the application can be improved. Moreover, application change accompanying the change of the storage unit is not required so that the storage area can be easily allocated to the application. Furthermore, the system administrator can allocate the storage area without being bothered by the arrangement restriction, thereby improving the efficiency of allocating the storage area to the application. Moreover, the best arrangement is automatically performed as much as possible so that the efficiency of allocating the storage area to the application can be improved. Furthermore, the system administrator can allocate the storage area without being bothered by the arrangement restriction among the database space area, the dictionary area, and the log area, thereby facilitating the allocation of the storage area to the database software. Moreover, the arrangement is automatically improved at the time of migration, thereby improving the efficiency of allocating the storage area accompanying the migration. Furthermore, the capacity of the data area can be easily increased, thereby reducing an operation load on the application.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A storage area allocating apparatus that allocates a storage area to be used by an application from a storage unit, the storage area allocating apparatus comprising:
a capacity calculating unit that identifies a data area for each type required by the application and calculates a capacity of identified data area; and
an area allocating unit that allocates a storage area having the capacity calculated by the capacity calculating unit as the data area from the storage unit.

2. The storage area allocating apparatus according to claim 1, wherein the area allocating unit allocates a virtual storage area having the capacity calculated by the capacity calculating unit as the data area, and allocates a real storage area corresponding to the virtual storage area.

3. The storage area allocating apparatus according to claim 1, wherein the area allocating unit allocates the storage area based on an arrangement restriction among the data areas.

4. The storage area allocating apparatus according to claim 3, wherein the arrangement restriction includes a best arrangement, which is a most desirable arrangement, and a minimum arrangement that satisfies a minimum necessary arrangement condition, and
the area allocating unit allocates the storage area according to the best arrangement, and when the best arrangement is not possible, allocates the storage area according to the minimum arrangement.

5. The storage area allocating apparatus according to claim 3, wherein the application includes database software,
the capacity calculating unit calculates a database space area for storing data, a dictionary area for storing dictionary information, and a log area for storing a log relative to the database software, and
the area allocating unit allocates the storage area from the storage unit based on the arrangement restriction among the database space area, the dictionary area, and the log area.

6. The storage area allocating apparatus according to claim 4, further comprising a migration unit that determines whether the storage unit can be allocated according to the best arrangement relative to the storage area allocated according to the minimum arrangement, at the time of shifting the storage area allocated as the data area, and when the storage unit can be allocated according to the best arrangement, allocates a new storage area with the best arrangement.

7. The storage area allocating apparatus according to claim 1, further comprising a capacity increasing unit that monitors a status of use of the data area by the application for each type, and when a proportion of the used area exceeds a predetermined threshold, increases the capacity of the data area exceeding the threshold, and also increases the capacity of other data areas used by the application.

8. A method of allocating a storage area to be used by an application from a storage unit, the method comprising:
identifying a data area for each type required by the application;
calculating a capacity of the data area identified at the identifying; and
allocating a storage area having the capacity calculated at the calculating as the data area from the storage unit.

9. A computer-readable recording medium that stores therein a computer program that causes a computer to implement allocating a storage area to be used by an application from a storage unit, the computer program causing the computer to execute:
identifying a data area for each type required by the application;
calculating a capacity of the data area identified at the identifying; and
allocating a storage area having the capacity calculated at the calculating as the data area from the storage unit.
